(19) United States
(12) Patent Application Publication
(10) Pub. No.: US 2025/0131292 A1
(43) Pub. Date: Apr. 24, 2025

(54) APPLYING RULES TO IMPROVE NEAREST NEIGHBOR MATCHING IN A SHARED EMBEDDING SPACE

(71) Applicant: Capital One Services, LLC, McLean, VA (US)

(72) Inventors: Owen REINERT, Queens, NY (US); Jeremy GOODSITT, Champaign, IL (US); Taylor TURNER, Richmond, VA (US); Justin AU-YEUNG, Somerville, MA (US)

(21) Appl. No.: 18/493,495

(22) Filed: Oct. 24, 2023

(51) Int. Cl. G06N 5/022

(52) U.S. Cl. CPC G06N 5/022

(57) ABSTRACT

In some implementations, a machine learning system may receive a set of first data structures associated with a set of users, may receive a set of second data structures associated with a set of entities, and may receive event information associated with the set of users and the set of entities. The machine learning system may generate an embedding space that represents the set of first data structures, the set of second data structures, and the event information. The machine learning system may disregard a portion of the set of second data structures, using a condition, in order to generate a subset of second data structures. The machine learning system may identify at least one relevant entity, from the subset of second data structures, using the embedding space. The machine learning system may generate a communication, associated with the at least one relevant entity, and may output the communication.

### BACKGROUND

Machine learning may be used to target communications to users. For example, machine learning models may predict user preferences (e.g., based on historical information associated with users) and select a communication to send to a user based on that user's predicted preferences.

### SUMMARY

Some implementations described herein relate to a system for applying rules to improve nearest neighbor matching. The system may include one or more memories and one or more processors communicatively coupled to the one or more memories. The one or more processors may be configured to receive a set of first data structures associated with a set of users. The one or more processors may be configured to receive a set of second data structures associated with a set of entities. The one or more processors may be configured to receive event information associated with the set of users and the set of entities. The one or more processors may be configured to generate an embedding space that encodes, a set of first nodes representing the set of users and based on the set of first data structures, a set of second nodes representing the set of entities and based on the set of second data structures, and a set of connections, between the set of first nodes and the set of second nodes, based on the event information. The one or more processors may be configured to identify a portion of the set of second nodes, for a selected first node in the set of first nodes, using a condition applied to the set of second nodes. The one or more processors may be configured to calculate weighted distances using a portion of the set of connections that corresponds to the portion of the set of second nodes and the selected first node. The one or more processors may be configured to generate at least one communication based on the weighted distances. The one or more processors may be configured to transmit the at least one communication to a user device associated with a user, in the set of users, represented by the selected first node.

Some implementations described herein relate to a method of applying rules to improve nearest neighbor matching. The method may include receiving, from a data source, a set of first data structures associated with a set of users. The method may include receiving, from the data source, a set of second data structures associated with a set of entities. The method may include receiving event information associated with the set of users and the set of entities. The method may include generating, by a machine learning system, an embedding space that represents the set of first data structures, the set of second data structures, and the event information. The method may include disregarding a portion of the set of second data structures, for a selected user in the set of users, using a condition in order to generate a subset of the set of second data structures. The method may include identifying at least one relevant entity, from the subset of the set of second data structures, using the embedding space. The method may include generating, by the machine learning system, at least one communication associated with the at least one relevant entity. The method may include outputting the at least one communication.

Some implementations described herein relate to a non-transitory computer-readable medium that stores a set of instructions for configuring rules to improve nearest neighbor matching. The set of instructions, when executed by one or more processors of a device, may cause the device to transmit, to a remote system, a registration message that authorizes a remote system to access event information. The set of instructions, when executed by one or more processors of the device, may cause the device to transmit, to the remote system, an indication of a condition. The set of instructions, when executed by one or more processors of the device, may cause the device to transmit, to the remote system, a data structure encoding at least one communication. The set of instructions, when executed by one or more processors of the device, may cause the device to receive, from the remote system, a confirmation that the at least one communication was sent to a selected user, based on an embedding space, that satisfies the condition.

### BRIEF DESCRIPTION OF THE DRAWINGS

FIGS. 1A-1E are diagrams of an example implementation relating to applying rules to improve nearest neighbor matching in a shared embedding space, in accordance with some embodiments of the present disclosure.

FIG. 2 is a diagram illustrating an example of training and using a machine learning model in connection with implementations described herein, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to applying rules to improve nearest neighbor matching in a shared embedding space, in accordance with some embodiments of the present disclosure.

### DETAILED DESCRIPTION

The following detailed description of example implementations refers to the accompanying drawings. The same reference numbers in different drawings may identify the same or similar elements.

Transmitting communications (e.g., email messages, text messages, and/or push notifications, among other examples) consumes power and processing resources (both at a remote device, such as a server, that transmits the communications and at user devices that receive the communications) as well as network overhead. Accordingly, to transmit fewer communications with comparable efficiency, machine learning may be used to target the communications at a set of users.

Using machine learning may include mapping users to entities with a common embedding space. Accordingly, a nearest neighbor algorithm may be applied to select a set of users to receive a communication. However, nearest neighbor algorithms are computationally expensive. Additionally, when the number of users is high, significant memory overhead is used to calculate nearest neighbors because each user's distance from an entity is calculated and stored.

Some implementations described herein enable a condition to cull a set of users before determining nearest neighbors to an entity in a common embedding space. Applying the condition allows for some users, in the set of users, to be discarded before a nearest neighbor algorithm is applied. As a result, computational complexity of the nearest neighbor algorithm is reduced, which conserves power and processing resources. Additionally, memory overhead is reduced because distances, from the discarded users to the entity, are not calculated and thus are not stored.

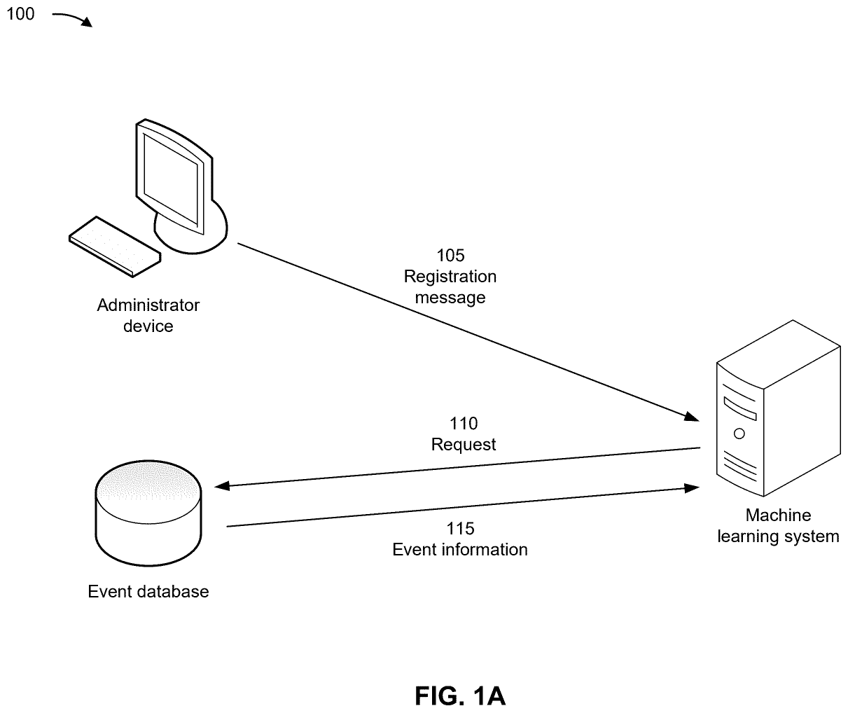

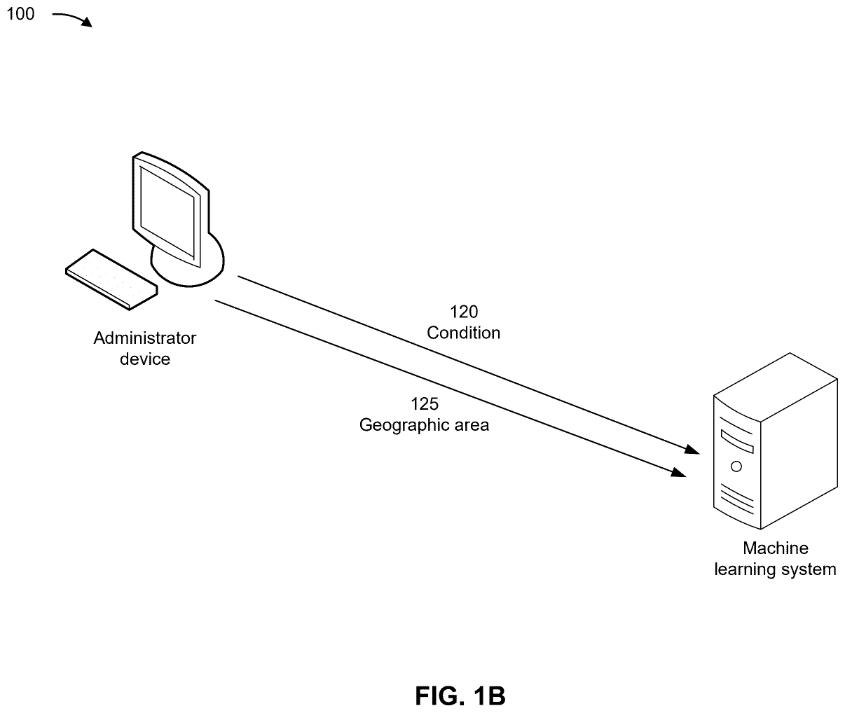

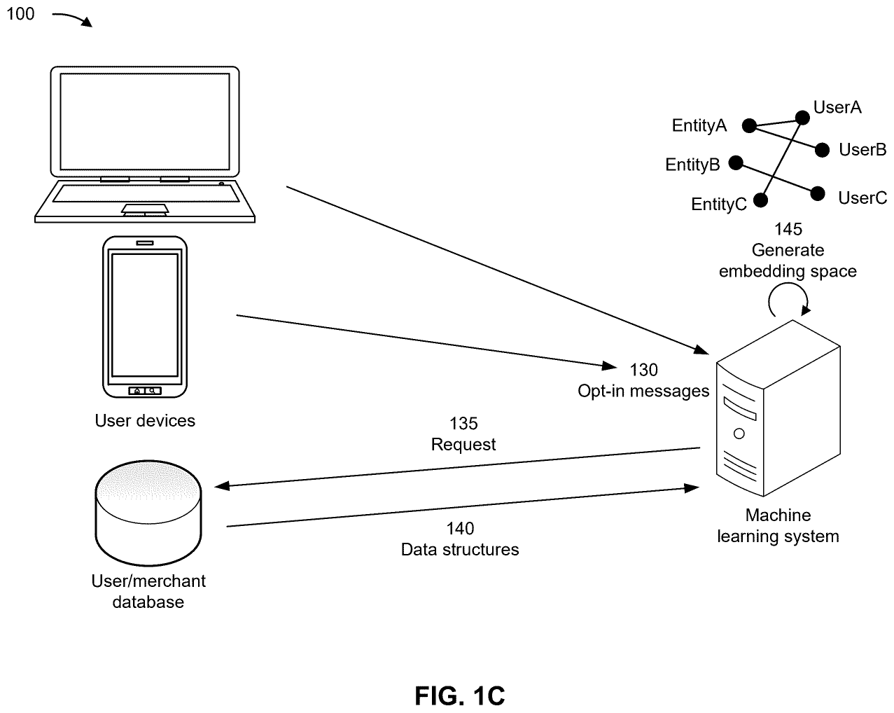

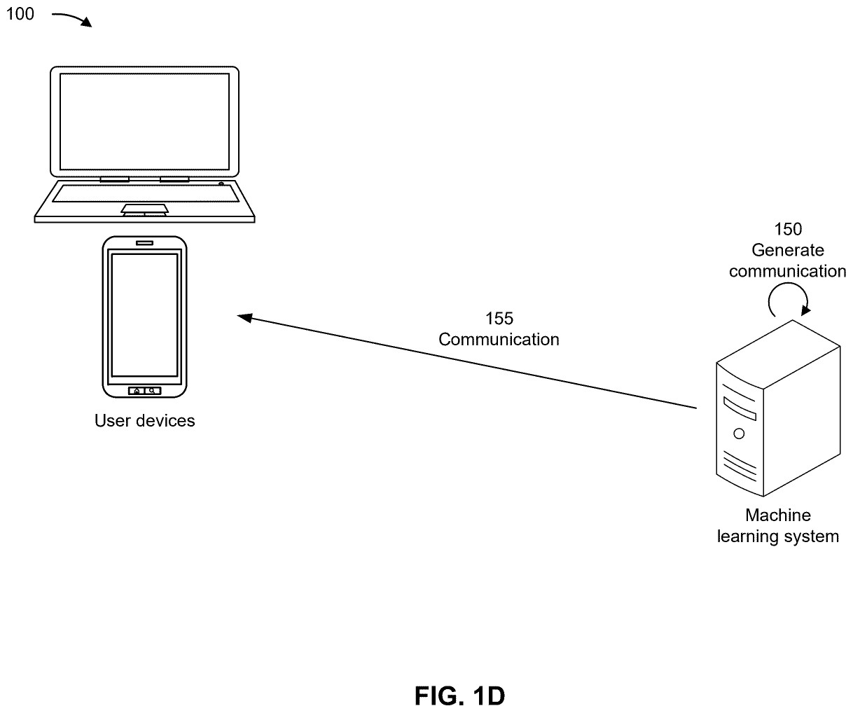

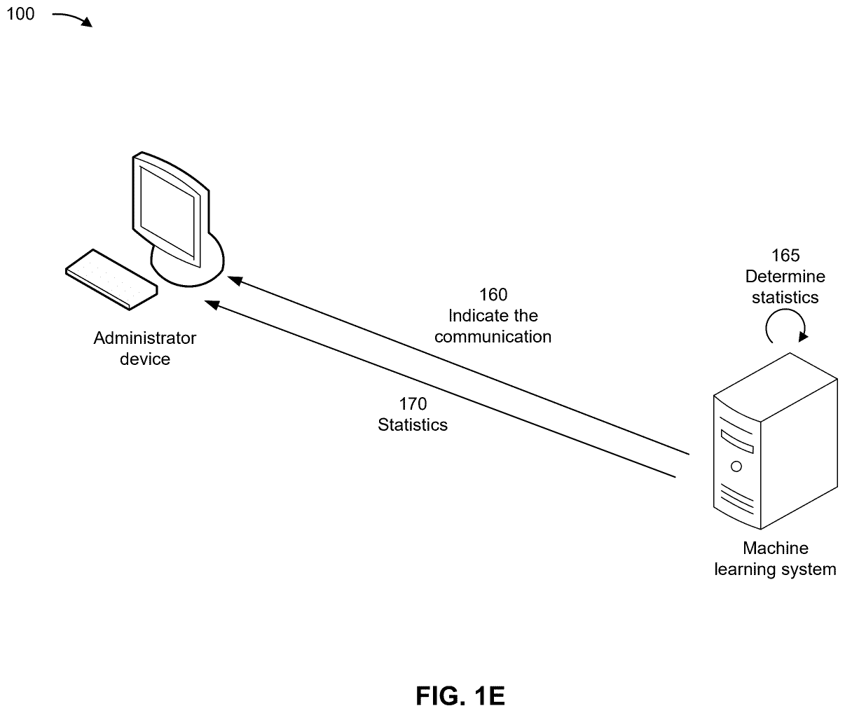

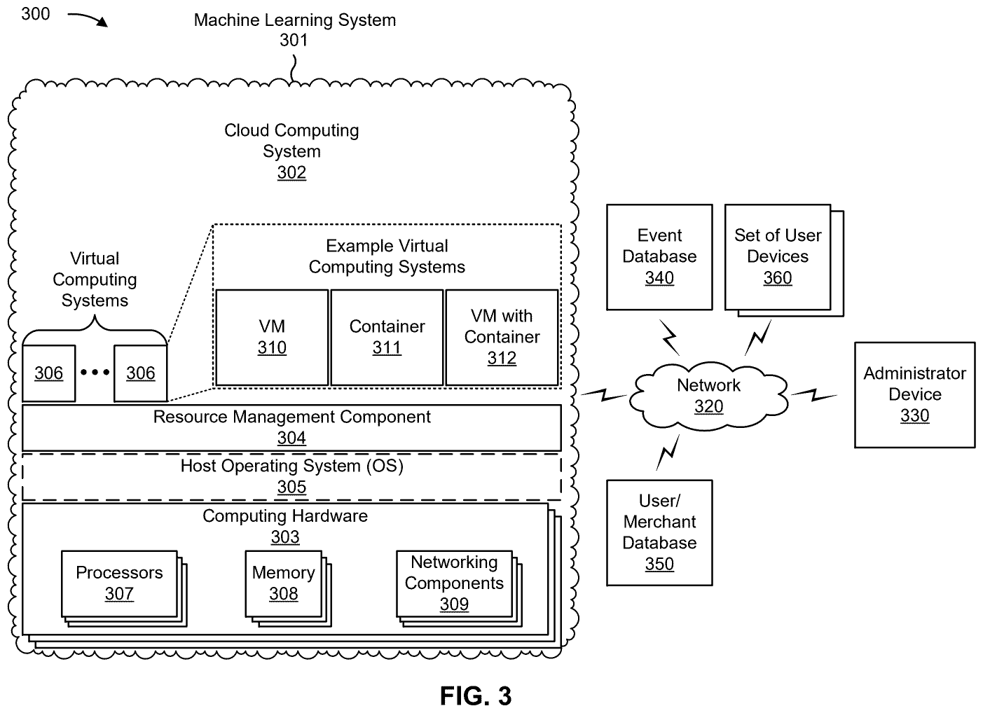

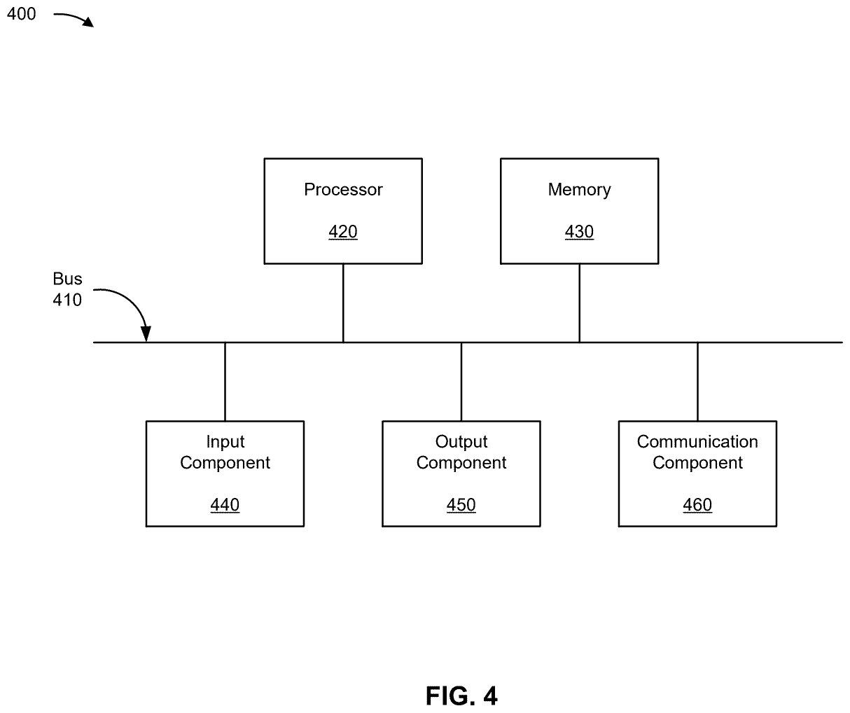

FIGS. 1A-1E are diagrams of an example 100 associated with applying rules to improve nearest neighbor matching in a shared embedding space. As shown in FIGS. 1A-1E, example 100 includes a machine learning system, an administrator device, an event database, a set of user devices, and a user/merchant database. These devices are described in more detail in connection with FIGS. 3 and 4.

As shown in FIG. 1A and by reference number 105, the administrator device may transmit, and the machine learning system may receive, a registration message. The machine learning system may be a remote system relative to the administrator device. For example, the administrator device may contact the machine learning system via a network (e.g., the Internet and/or an intranet, among other examples). In some implementations, a user of the administrator device may interact with the administrator device (e.g., via an input component of the administrator device) to trigger the administrator device to transmit the registration message. For example, a web browser (or another type of application) executed by the administrator device may output a user interface (UI) (e.g., via an output component of the administrator device), and the user may interact with the UI to trigger the administrator device to transmit the registration message.

The registration message may authorize the machine learning system to access event information. For example, the event information may be stored locally (e.g., on a cache and/or another type of memory controlled by the machine learning system) and/or may be stored at least partially separate (e.g., logically, virtually, and/or physically) from the machine learning system. The registration message may include a set of credentials associated with the event information. For example, the set of credentials may include a username and password, a certificate, a private key, an access token, and/or biometric information, among other examples.

As shown by reference number 110, the machine learning system may transmit, and the event database may receive, a request for the event information. For example, the request may include a hypertext transfer protocol (HTTP) request and/or an application programming interface (API) call, among other examples. The request may include (e.g., in a header and/or as an argument) an indication of an entity for which the machine learning system is requesting event information. For example, the administrator device may be associated with a merchant, and the machine learning system may indicate the merchant in the request. Additionally, in some implementations, the request may include the set of credentials, as described above. Alternatively, the machine learning system may use the set of credentials to authenticate itself with the event database separately from transmitting the request. The machine learning system may transmit the request according to a schedule (e.g., once per hour or once per day, among other examples) and/or on demand (e.g., in response to a command). For example, the registration message from the administrator device may trigger the machine learning system to transmit the request.

As described above, the event information may be associated with an entity (e.g., a merchant). Additionally, in some implementations, the event information may further be associated with other entities (e.g., other merchants). For example, the machine learning system may be managed by (or at least associated with) a financial institution and/or a payment processor, and the event information may encode events associated with a plurality of entities served by the financial institution and/or the payment processor.

As shown by reference number 115, the event database may transmit, and the machine learning system may receive, the event information. The event database may transmit the event information in response to the request from the machine learning system. The event information may be included in an HTTP response and/or a return from an API call (e.g., as described above).

As shown in FIG. 1B and by reference number 120, the administrator device may transmit, and the machine learning system may receive, an indication of a condition. The indication may include a selection of the condition from a plurality of candidate conditions. The condition may indicate that only users who are new customers should be selected, that only users who are existing customers should be selected, and/or that only users who frequented the entity in a time window (e.g., the previous week or more than one week ago, among other examples) should be selected, among other examples.

In some implementations, the user of the administrator device may interact with the administrator device (e.g., via an input component of the administrator device) to trigger the administrator device to transmit the indication of the condition. For example, a web browser (or another type of application) executed by the administrator device may output a UI (e.g., via an output component of the administrator device), and the user may interact with the UI to trigger the administrator device to transmit the indication. In some implementations, the administrator device may transmit the indication of the condition in the registration message described above. Alternatively, the administrator device may transmit the indication of the condition separately (e.g., in response to a prompt received from the machine learning system).

Additionally, or alternatively, as shown by reference number 125, the administrator device may transmit, and the machine learning system may receive, an indication of a geographic area. The indication may include a zip code, a name of a metropolitan area, a set of coordinates that form a closed Cartesian shape, and/or another type of geographic indicator. The user of the administrator device may trigger the administrator device to transmit the indication of the geographic area similarly as described above for the indication of the condition. In some implementations, the administrator device may transmit the indication of the geographic area in the registration message described above. Additionally, or alternatively, the administrator device may transmit the indication of the geographic area in a same message as includes the indication of the condition. Additionally, or alternatively, the administrator device may transmit the indication of the geographic area separately from the registration message and/or the indication of the condition (e.g., in response to a prompt received from the machine learning system).

As shown in FIG. 1C and by reference number 130, the set of user devices may transmit, and the machine learning system may receive, a set of opt-in messages associated with a set of users. In some implementations, the set of users may interact with the set of user devices (e.g., via a set of input components) to trigger the set of user devices to transmit the set of opt-in messages. For example, a web browser (or another type of application) executed by each user device may output a UI (e.g., via an output component of the user device), and a corresponding user may interact with the UI to trigger the user device to transmit a corresponding opt-in message. Although the example 100 shows the set of opt-in messages as simultaneous, other examples may include the machine learning system receiving the set of opt-in messages over time (e.g., a first opt-in message at a first time, a second opt-in message at a second time after the first time, and so on).

The set of opt-in messages may authorize the machine learning system to access user information. For example, the user information may be stored locally (e.g., on a cache and/or another type of memory controlled by the machine learning system) and/or may be stored at least partially separate (e.g., logically, virtually, and/or physically) from the machine learning system. The set of opt-in messages may include sets of credentials associated with the user information. For example, the sets of credentials may include usernames and passwords, certificates, private keys, access tokens, and/or biometric information, among other examples.

As shown by reference number 135, the machine learning system may transmit, and the user/merchant database may receive, a request for user information. For example, the request may include an HTTP request and/or an API call, among other examples. The request may include (e.g., in a header and/or as an argument) an indication of the set of users for which the machine learning system is requesting user information. For example, the set of user devices may be associated with the set of users, and the machine learning system may indicate the set of users associated with the set of opt-in messages from the set of user devices. Additionally, in some implementations, the request may include a set of credentials that authorize the machine learning system to access the user information (e.g., received in the set of opt-in messages, as described above). Alternatively, the machine learning system may use the set of credentials to authenticate itself with the user/merchant database separately from transmitting the request. The machine learning system may transmit the request according to a schedule (e.g., once per hour or once per day, among other examples) and/or on demand (e.g., in response to a command). For example, the set of opt-in messages from the set of user devices may trigger the machine learning system to transmit the request.

As shown by reference number 140, the user/merchant database may transmit, and the machine learning system may receive, set of first data structures associated with the set of users. The user/merchant database may transmit the set of first data structures in response to the request from the machine learning system. The set of first data structures may be included in an HTTP response and/or a return from an API call (e.g., as described above). The set of first data structures may include demographic information (e.g., socioeconomic information and/or age information, among other examples), financial information (e.g., credit card balances and/or credit card limits, among other examples), and/or event information (e.g., indicating transactions performed by the set of users).

Additionally, the user/merchant database may transmit, and the machine learning system may receive, a set of second data structures associated with a set of entities (e.g., merchants). The set of second data structures may include geographic information (e.g., addresses and/or coordinates, among other examples), operating information (e.g., days open and/or hours of operation, among other examples), and/or event information (e.g., indicating transactions performed at the set of entities).

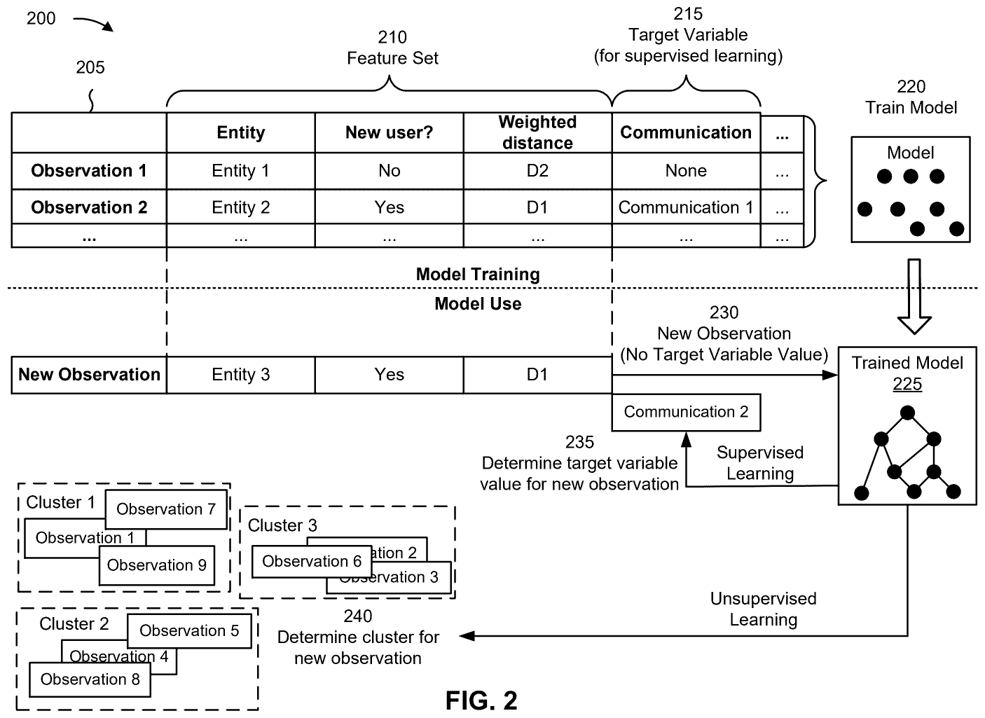

As shown by reference number 145, the machine learning system may generate an embedding space that represents the set of first data structures, the set of second data structures, and the event information. For example, the machine learning system may apply a machine learning model (e.g., trained and used similarly as the model described in connection with FIG. 2) to generate the embedding space. The embedding space may encode a set of first nodes representing the set of users and based on the set of first data structures (e.g., shown as “UserA,” “UserB,” and “UserC” in the example 100), a set of second nodes representing the set of entities and based on the set of second data structures (e.g., shown as “EntityA,” “EntityB,” and “EntityC” in the example 100), and a set of connections, between the set of first nodes and the set of second nodes, based on the event information (e.g., shown as connecting segments in the example 100). The embedding space may thus be a multi-dimensional space associated with a plurality of factors; by encoding both users and entities with the same plurality of factors, the first nodes and second nodes may be represented on the same multi-dimensional space.

Based on the embedding space, the machine learning system may apply the condition to identify a portion, of the set of second nodes, for a selected first node in the set of first nodes. The machine learning system may determine the selected first node randomly (or pseudo-randomly) or according to a sequence. The machine learning system may determine which second nodes (and thus which second data structures) fail to satisfy the condition for the selected first node (and thus the selected first data structure). Therefore, the machine learning system may disregard a portion of the set of second data structures, for the selected user and using the condition, in order to generate a subset of the set of second data structures. Additionally, or alternatively, the machine learning system may apply the geographic area to disregard the portion of the set of second data structures. For example, the machine learning system may disregard second nodes (and thus second data structures) based on whether a geographic area associated with the selected first node (and thus the selected first data structure) overlaps with geographic areas indicated for the set of second nodes.

The machine learning system may additionally calculate weighted distances using a portion of the set of connections that corresponds to the portion of the set of second nodes and the selected first node. In other words, multi-dimensional distances between a subset of the set of entities and the selected user may represent relevances of the subset of entities to the selected user (e.g., based on the condition and/or the event information). The distance may be weighted by one or more factors. For example, distance may be weighted by a payment provided by the entity in exchange for sending a communication (e.g., as described in connection with FIG. 1D). Additionally, or alternatively, the machine learning system may receive a set of weights associated with the set of entities, and apply the set of weights to calculate the weighted distances. Because the machine learning system disregarded the portion of the set of second nodes, the machine learning system expends less power and fewer processing resources in calculating the weighted distances. Additionally, because the machine learning system calculates fewer weighted distances as compared with using the full set of second nodes, memory overhead is reduced.

As shown in FIG. 1D and by reference number 150, the machine learning system may generate a communication (e.g., at least one communication or a plurality of communications). In some implementations, the machine learning system may apply a machine learning model in order to generate the communication (e.g., as described in connection with FIG. 2). The machine learning model that generates the communication may be the same machine learning model as generates the embedding space (e.g., as described above). The machine learning model may be trained and/or hosted by the machine learning system or by a device at least partially separate from the machine learning system (e.g., a standalone server, a device 400 of FIG. 4, and/or another type of computing device).

The machine learning system may generate the communication based on the weighted distances. For example, the machine learning system may identify a relevant entity (e.g., at least one relevant entity), represented by a second node in the portion of the set of second nodes, as a nearest neighbor using the weighted distances. Therefore, the machine learning model may include a nearest neighbor algorithm. Additionally, or alternatively, the machine learning system may apply the nearest neighbor algorithm to identify the relevant entity and may select the communication associated with the relevant entity.

In some implementations, the administrator device may transmit, and the machine learning system may receive, at least a portion of the communication. For example, the portion of the communication may include text and/or multimedia (e.g., to include in an email message or a text message). Alternatively, the administrator device may transmit data structure encoding the communication (e.g., a .msg file encoding an email message, among other examples). In a combinatory example, the administrator device may transmit multiple candidate communications (or portions thereof), and the machine learning system may select from the candidate communications (e.g., using a machine learning model, as described in connection with FIG. 2, and/or a nearest neighbor algorithm, as described above).

The user of the administrator device may trigger the administrator device to transmit the (portion of the) communication similarly as described above for the indication of the condition. In some implementations, the administrator device may transmit the (portion of the) communication in the registration message described above. Additionally, or alternatively, the administrator device may transmit the (portion of the) communication in a same message as includes the indication of the condition and/or the indication of the geographic area. Additionally, or alternatively, the administrator device may transmit the (portion of the) communication separately from the registration message, the indication of the condition, and/or the indication of the geographic area (e.g., in response to a prompt received from the machine learning system).

As shown by reference number 155, the machine learning system may transmit, and a user device (e.g., one or more user devices) associated with a user represented by the selected first node may receive, the communication. For example, the machine learning system may cooperate with an email server (e.g., when the communication is an email message), a telecommunications network (e.g., when the communication is a text message), and/or another type of messaging service in order to deliver the communication. The event information may be associated with a first time period, and the communication may be associated with a second time period subsequent to the first time period. Thus, the event information may represent historical information (e.g., the first time period being in the past), and the communication may represent a future offer (e.g., the second time period being in the future).

As shown in FIG. 1E and by reference number 160, the machine learning system may transmit, and the administrator device may receive, an indication that the communication was output. In some implementations, the indication may further indicate the selected user (e.g., using an anonymized identifier to preserve privacy).

As shown by reference number 165, the machine learning system may determine statistics associated with the communication. For example, the machine learning system may determine whether the selected user actually read the communication. In another example, the machine learning system may determine whether the user frequented the relevant entity after receiving the communication (e.g., using additional event information associated with the set of users). Accordingly, the statistics may represent performance of the communication.

As shown by reference number by reference number 170, the machine learning system may transmit, and the administrator device may receive, an indication of the statistics. For example, because the entity associated with the administrator device may provide payment based on performance of the communication, the indication may include an amount associated with transmitting the communication (e.g., calculated based on whether the selected user actually read the communication and/or whether the selected user frequented the relevant entity after receiving the communication, among other examples). The indication of the statistics may be included in a same message as the indication that the communication was output or may be transmitted separately.

The processes described in connection with FIGS. 1A-1E may be iterative. For example, the machine learning system may generate communications for each user in the set of users. Accordingly, the machine learning system may transmit different communications to different users over time. Additionally, or alternatively, the machine learning system may periodically (or upon request from the administrator device) calculate new weighted distances for a selected user and, based on the new weighted distances generate (or refrain from generating) a new communication. Accordingly, the machine learning system may transmit different communications to the selected user over time.

By using techniques as described in connection with FIGS. 1A-1E, the machine learning system applies a condition to discard a portion of the set of entities before determining nearest neighbors in the common embedding space. As a result, computational complexity of the nearest neighbor algorithm is reduced, which conserves power and processing resources. Additionally, memory overhead is reduced because distances, from the discarded entities to the selected user, are not calculated and thus are not stored.

Although the example 100 is described with selecting a first node and disregarding a portion of the second nodes, other examples may include a reverse order of operations. For example, the machine learning system may apply the condition to identify a portion, of the set of first nodes, for a selected second node in the set of second nodes. The machine learning system may determine the selected second node randomly (or pseudo-randomly) or according to a sequence. The machine learning system may determine which first nodes (and thus which first data structures) fail to satisfy the condition for the selected second node (and thus the selected second data structure). Therefore, the machine learning system may disregard a portion of the set of first data structures, for the selected entity and using the condition, in order to generate a subset of the set of first data structures.

As indicated above, FIGS. 1A-1E are provided as an example. Other examples may differ from what is described with regard to FIGS. 1A-1E.

FIG. 2 is a diagram illustrating an example 200 of training and using a machine learning model in connection with applying rules to improve nearest neighbor matching in a shared embedding space. The machine learning model training and usage described herein may be performed using a machine learning system. The machine learning system may include or may be included in a computing device, a server, a cloud computing environment, or the like, as described in more detail in connection with FIG. 3.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from an event database and/or a user/merchant database, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the event database and/or the user/merchant database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of which entity is under consideration, a second feature of whether a selected user is a new user for the entity, a third feature of weighted distance between the selected user and the entity, and so on. As shown, for a first observation, the first feature may have a value of “Entity 1,” the second feature may have a value of “No,” the third feature may have a value of D2, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a selected communication, which has a value of null for the first observation.

The feature set and target variable described above are provided as examples, and other examples may differ from what is described above. For example, the machine learning model may determine whether an entity is to be included (e.g., a target variable of “yes” or “no”) rather than determining a communication.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on event information. For example, the event information may be labeled based on which entities were relevant to users in the past, and the machine learning system may use the labeled event information for training. In another example, the event information may be unlabeled, and the machine learning system may use deep learning for training.

As shown by reference number 230, the machine learning system may apply the trained machine learning model 225 to a new observation, such as by receiving a new observation and inputting the new observation to the trained machine learning model 225. As shown, the new observation may include a first feature of “Entity 3,” a second feature of “Yes,” a third feature of D1, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of communication #2 for the target variable of a selected communication for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to transmit communication #2 to a user associated with the new observation. The first automated action may include, for example, transmitting communication #2 to the user associated with the new observation.

As another example, if the machine learning system were to predict a value of communication #1 for the target variable of a selected communication, then the machine learning system may provide a second (e.g., different) recommendation (e.g., a recommendation to transmit communication #1 to a user associated with the observation) and/or may perform or cause performance of a second (e.g., different) automated action (e.g., transmitting communication #1 to the user associated with the observation).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., associated with communication #2), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., associated with no communication), then the machine learning system may provide a second (e.g., different) recommendation (e.g., refraining from transmitting a communication to a user associated with the new observation) and/or may perform or cause performance of a second (e.g., different) automated action, such as discarding an entity associated with the new observation from a list of relevant entities for the user.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include whether a user viewed the communication, whether the user frequented an entity associated with the communication, and/or a rating from the user associated with the communication, among other examples.

In this way, the machine learning system may apply a rigorous and automated process to targeting communications based on nearest neighbors. The machine learning system may enable recognition and/or identification of tens, hundreds, thousands, or millions of features and/or feature values for tens, hundreds, thousands, or millions of observations, thereby increasing accuracy and consistency and reducing delay associated with transmitting communications indiscriminately.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a machine learning system 301, which may include one or more elements of and/or may execute within a cloud computing system 302. The cloud computing system 302 may include one or more elements 303-312, as described in more detail below. As further shown in FIG. 3, environment 300 may include a network 320, an administrator device 330, an event database 340, a user/merchant database 350, and/or a set of user devices 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the machine learning system 301 may include one or more elements 303-312 of the cloud computing system 302, may execute within the cloud computing system 302, and/or may be hosted within the cloud computing system 302, in some implementations, the machine learning system 301 may not be cloud-based (e.g., may be implemented outside of a cloud computing system) or may be partially cloud-based. For example, the machine learning system 301 may include one or more devices that are not part of the cloud computing system 302, such as device 400 of FIG. 4, which may include a standalone server or another type of computing device. The machine learning system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The administrator device 330 may include one or more devices capable of receiving, generating, storing, processing, and/or providing registration messages, as described elsewhere herein. The administrator device 330 may include a communication device and/or a computing device. For example, the administrator device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 330 may communicate with one or more other devices of environment 300, as described elsewhere herein.

The event database 340 may be implemented using one or more devices capable of receiving, generating, storing, processing, and/or providing event information, as described elsewhere herein. The event database 340 may be implemented using a communication device and/or a computing device. For example, the event database 340 may be implemented using a server, a database server, an application server, a client server, a web server, a host server, a proxy server, a virtual server (e.g., executing on computing hardware), a server in a cloud computing system, a device that includes computing hardware used in a cloud computing environment, or a similar type of device. The event database 340 may communicate with one or more other devices of environment 300, as described elsewhere herein.

The user/merchant database 350 may be implemented using one or more devices capable of receiving, generating, storing, processing, and/or providing data structures, as described elsewhere herein. The user/merchant database 350 may be implemented using a communication device and/or a computing device. For example, the user/merchant database 350 may be implemented using a server, a database server, an application server, a client server, a web server, a host server, a proxy server, a virtual server (e.g., executing on computing hardware), a server in a cloud computing system, a device that includes computing hardware used in a cloud computing environment, or a similar type of device. The user/merchant database 350 may communicate with one or more other devices of environment 300, as described elsewhere herein.

The set of user devices 360 may include one or more devices capable of receiving, generating, storing, processing, and/or providing opt-in messages, as described elsewhere herein. The set of user devices 360 may include a set of communication devices and/or computing devices. For example, the set of user devices 360 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The set of user devices 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with applying rules to improve nearest neighbor matching in a shared embedding space. The device 400 may correspond to an administrator device 330, a device implementing an event database 340, a device implementing a user/merchant database 350, and/or a set of user devices 360. In some implementations, an administrator device 330, a device implementing an event database 340, a device implementing a user/merchant database 350, and/or a set of user devices 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

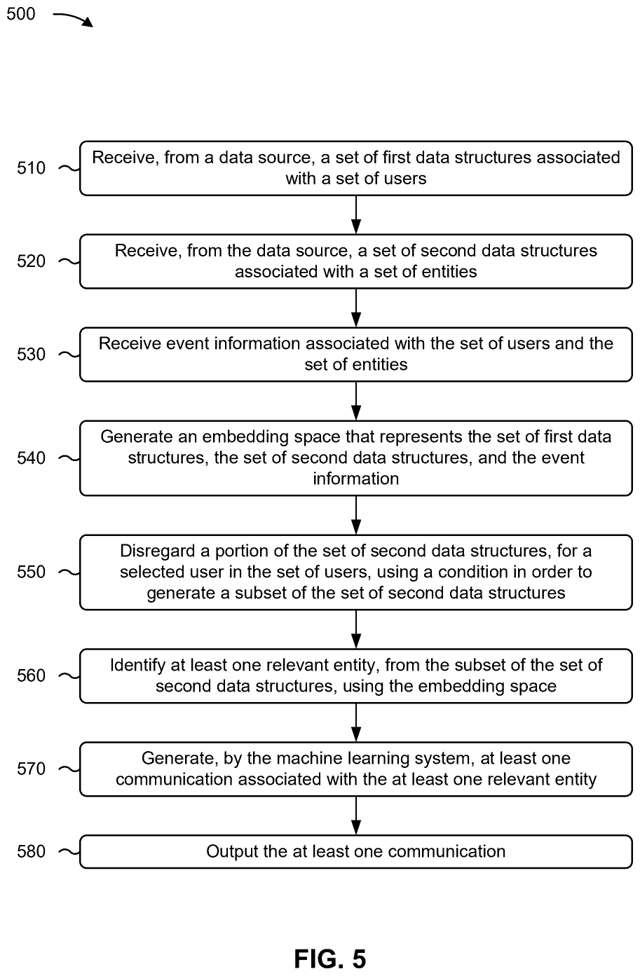

FIG. 5 is a flowchart of an example process 500 associated with applying rules to improve nearest neighbor matching in a shared embedding space. In some implementations, one or more process blocks of FIG. 5 may be performed by a machine learning system 301. In some implementations, one or more process blocks of FIG. 5 may be performed by another device or a group of devices separate from or including the machine learning system 301, such as an administrator device 330, a device implementing an event database 340, a device implementing a user/merchant database 350, and/or a set of user devices 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a data source, a set of first data structures associated with a set of users (block 510). For example, the machine learning system 301 (e.g., using processor 420, memory 430, input component 440, and/or communication component 460) may receive, from a data source, a set of first data structures associated with a set of users, as described above in connection with reference number 140 of FIG. 1C. As an example, a user/merchant database may transmit the set of first data structures in response to a request from the machine learning system 301. The set of first data structures may be included in an HTTP response and/or a return from an API call. The set of first data structures may include demographic information (e.g., socioeconomic information and/or age information, among other examples), financial information (e.g., credit card balances and/or credit card limits, among other examples), and/or event information (e.g., indicating transactions performed by the set of users).

As further shown in FIG. 5, process 500 may include receiving, from the data source, a set of second data structures associated with a set of entities (block 520). For example, the machine learning system 301 (e.g., using processor 420, memory 430, input component 440, and/or communication component 460) may receive, from the data source, a set of second data structures associated with a set of entities, as described above in connection with reference number 140 of FIG. 1C. As an example, a user/merchant database may transmit the set of second data structures in response to a request from the machine learning system 301. The set of second data structures may be included in an HTTP response and/or a return from an API call. The set of second data structures may include geographic information (e.g., addresses and/or coordinates, among other examples), operating information (e.g., days open and/or hours of operation, among other examples), and/or event information (e.g., indicating transactions performed at the set of entities).

As further shown in FIG. 5, process 500 may include receiving event information associated with the set of users and the set of entities (block 530). For example, the machine learning system 301 (e.g., using processor 420, memory 430, input component 440, and/or communication component 460) may receive event information associated with the set of users and the set of entities, as described above in connection with reference number 115 of FIG. 1A. As an example, an event database may transmit the event information in response to a request from the machine learning system 301. The event information may be included in an HTTP response and/or a return from an API call.

As further shown in FIG. 5, process 500 may include generating an embedding space that represents the set of first data structures, the set of second data structures, and the event information (block 540). For example, the machine learning system 301 (e.g., using processor 420 and/or memory 430) may generate an embedding space that represents the set of first data structures, the set of second data structures, and the event information, as described above in connection with reference number 145 of FIG. 1C. As an example, the embedding space may encode a set of first nodes representing the set of users and based on the set of first data structures, a set of second nodes representing the set of entities and based on the set of second data structures, and a set of connections, between the set of first nodes and the set of second nodes, based on the event information. The embedding space may thus be a common embedding space for both users and entities.

As further shown in FIG. 5, process 500 may include disregarding a portion of the set of second data structures, for a selected user in the set of users, using a condition in order to generate a subset of the set of second data structures (block 550). For example, the machine learning system 301 (e.g., using processor 420 and/or memory 430) may disregard a portion of the set of second data structures, for a selected user in the set of users, using a condition in order to generate a subset of the set of second data structures, as described above in connection with FIG. 1C. As an example, machine learning system 301 may determine which second nodes (and thus which second data structures) fail to satisfy the condition for a selected first node (associated with the selected user). Therefore, the machine learning system may disregard the portion of the set of second data structures for the selected user and using the condition.

As further shown in FIG. 5, process 500 may include identifying at least one relevant entity, from the subset of the set of second data structures, using the embedding space (block 560). For example, the machine learning system 301 (e.g., using processor 420 and/or memory 430) may identify at least one relevant entity, from the subset of the set of second data structures, using the embedding space, as described above in connection with FIG. 1C. As an example, the machine learning system 301 may calculate weighted distances using a portion of the set of connections that corresponds to the portion of the set of second nodes and the selected user. Because the weighted distances represent relevances of a subset of entities to the selected user, the machine learning system 301 may determine the relevant entity using a nearest neighbor algorithm and the weighted distances.

As further shown in FIG. 5, process 500 may include generating at least one communication associated with the at least one relevant entity (block 570). For example, the machine learning system 301 (e.g., using processor 420 and/or memory 430) may generate at least one communication associated with the at least one relevant entity, as described above in connection with reference number 150 of FIG. 1D. As an example, the machine learning system 301 may apply a machine learning model in order to generate the communication (e.g., as described in connection with FIG. 2). Additionally, or alternatively, the machine learning system 301 may select from a plurality of candidate communications.

As further shown in FIG. 5, process 500 may include outputting the at least one communication (block 580). For example, the machine learning system 301 (e.g., using processor 420, memory 430, and/or output component 450) may output the at least one communication, as described above in connection with reference number 155 of FIG. 1D. As an example, the machine learning system 301 may cooperate with an email server (e.g., when the at least one communication includes an email message), a telecommunications network (e.g., when the at least one communication includes a text message), and/or another type or messaging service in order to deliver the at least one communication.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for applying rules to improve nearest neighbor matching, the system comprising:
one or more memories; and
one or more processors, communicatively coupled to the one or more memories, configured to:
receive a set of first data structures associated with a set of users;
receive a set of second data structures associated with a set of entities;
receive event information associated with the set of users and the set of entities;
generate an embedding space that encodes:
a set of first nodes representing the set of users and based on the set of first data structures,
a set of second nodes representing the set of entities and based on the set of second data structures, and
a set of connections, between the set of first nodes and the set of second nodes, based on the event information;
identify a portion of the set of second nodes, for a selected first node in the set of first nodes, using a condition applied to the set of second nodes;
calculate weighted distances using a portion of the set of connections that corresponds to the portion of the set of second nodes and the selected first node;
generate at least one communication based on the weighted distances; and
transmit the at least one communication to a user device associated with a user, in the set of users, represented by the selected first node.

2. The system of claim 1, wherein the one or more processors are configured to:
receive a set of credentials associated with the event information,
wherein the event information is received using the set of credentials.

3. The system of claim 1, wherein the one or more processors are configured to:
receive a set of opt-in messages associated with the set of users,
wherein the set of first nodes are generated in response to the set of opt-in messages.

4. The system of claim 1, wherein the one or more processors are configured to:
receive a set of weights associated with the set of entities,
wherein the weighted distances are calculated using the set of weights.

5. The system of claim 1, wherein the one or more processors are configured to:
identify at least one relevant entity, represented by a second node in the portion of the set of second nodes, as a nearest neighbor using the weighted distances,
wherein the at least one communication is associated with the at least one relevant entity.

6. The system of claim 1, wherein the one or more processors, to generate the at least one communication, are configured to:
select the at least one communication, from a plurality of candidate communications, using the weighted distances.

7. The system of claim 1, wherein the event information is associated with a first time period, and the at least one communication is associated with a second time period subsequent to the first time period.

8. A method of applying rules to improve nearest neighbor matching, comprising:
receiving, from a data source, a set of first data structures associated with a set of users;
receiving, from the data source, a set of second data structures associated with a set of entities;
receiving event information associated with the set of users and the set of entities;
generating, by a machine learning system, an embedding space that represents the set of first data structures, the set of second data structures, and the event information;
disregarding a portion of the set of second data structures, for a selected user in the set of users, using a condition in order to generate a subset of the set of second data structures;
identifying at least one relevant entity, from the subset of the set of second data structures, using the embedding space;
generating, by the machine learning system, at least one communication associated with the at least one relevant entity; and
outputting the at least one communication.

9. The method of claim 8, further comprising:
receiving, from an administrator device, an indication of the condition.

10. The method of claim 8, further comprising:
receiving, from an administrator device, a data structure encoding the at least one communication.

11. The method of claim 8, further comprising:
receiving, from an administrator device, a data structure encoding a plurality of candidate communications,
wherein the at least one communication is generated from the plurality of candidate communications.

12. The method of claim 8, further comprising:
transmitting, to an administrator device, an indication that the at least one communication was output.

13. The method of claim 8, further comprising:
transmitting, to an administrator device, an indication of an amount associated with output of the at least one communication.

14. The method of claim 8, wherein outputting the at least one communication comprises:
transmitting the at least one communication to a user device associated with the selected user.

15. A non-transitory computer-readable medium storing a set of instructions for configuring rules to improve nearest neighbor matching, the set of instructions comprising:
one or more instructions that, when executed by one or more processors of a device, cause the device to:
transmit, to a remote system, a registration message that authorizes a remote system to access event information;
transmit, to the remote system, an indication of a condition;
transmit, to the remote system, a data structure encoding at least one communication; and
receive, from the remote system, a confirmation that the at least one communication was sent to a selected user, based on an embedding space, that satisfies the condition.

16. The non-transitory computer-readable medium of claim 15, wherein the registration message includes a set of credentials associated with the event information.

17. The non-transitory computer-readable medium of claim 15, wherein the indication of the condition includes a selection of the condition from a plurality of candidate conditions.

18. The non-transitory computer-readable medium of claim 15, wherein the confirmation indicates the selected user.

19. The non-transitory computer-readable medium of claim 15, wherein the one or more instructions, when executed by the one or more processors, cause the device to:
receive, from the remote system, an indication of an amount associated with transmission of the at least one communication.

20. The non-transitory computer-readable medium of claim 15, wherein the one or more instructions, when executed by the one or more processors, further cause the device to:
transmit, to the remote system, an indication of a geographic area,
wherein the confirmation is received based on the selected user being associated with the geographic area.
